(19) United States
(12) Patent Application Publication
(10) Pub. No.: US 2015/0089995 A1
(43) Pub. Date: Apr. 2, 2015

(54) CRASH TEST METHOD AND APPARATUS WITH YAW SIMULATION

(71) Applicants: Ronald Lilley, Federal Way, WA (US); Brian Coughren, Murrieta, CA (US); Matthew Sikora, Auburn, WA (US); Thomas Wittmann, Seattle, WA (US)

(72) Inventors: Ronald Lilley, Federal Way, WA (US); Brian Coughren, Murrieta, CA (US); Matthew Sikora, Auburn, WA (US); Thomas Wittmann, Seattle, WA (US)

(21) Appl. No.: 14/449,999

(22) Filed: Aug. 1, 2014

Related U.S. Application Data
(60) Provisional application No. 61/861,762, filed on Aug. 2, 2013.

(51) Int. Cl. G01M 17/007

(52) U.S. Cl. CPC G01M 17/0078
USPC 73/12.07

(57) ABSTRACT

The present disclosure relates to accelerator type crash simulation test systems. These systems provide repeatable and reliable simulation of vehicle frontal impact crash events. The crash simulation test systems are capable of simulating motion in the form of rotation about a vertical Z-axis and/or translation in a direction perpendicular to the motion of the ServoSled. The combination of these motions is generally known as yaw. Yaw motion is of particular interest in frontal crash events in which the center of impact is offset from the center of the vehicle. The yaw motion can be achieved, for example, in several embodiments by the use of off-board actuators that supply yawing motions to an onboard platform.

### CROSS-REFERENCE TO RELATED APPLICATION

This application claims the benefit of U.S. Provisional Application No. 61/861762, filed Aug. 2, 2013, the disclosure of which is incorporated by reference herein.

### FIELD OF THE DISCLOSURE

The present disclosure relates to systems and methods in which the dynamic conditions attendant a vehicle crash are simulated in order to evaluate cabin design and vehicle safety systems, such as occupant restraint devices. More specifically, the present disclosure relates to non-destructive crash tests that include the simulation of vehicle yaw.

### BACKGROUND

To evaluate vehicle crash worthiness and occupant safety, vehicle manufacturers and regulatory agencies conduct full-scale crash tests in which a vehicle is caused to collide with an obstacle in a manner that duplicates a real world collision. Sensors, located on the vehicle and/or crash test dummies that are placed in the vehicle, provide data that is recorded for analysis and evaluation.

Full-scale crash testing is expensive because it destroys the test vehicle, which in some cases is an expensive prototype or an early stage production unit of limited availability. The expense and the possible lack of additional test vehicles limit the amount of full-scale crash tests that can be conducted, thereby impeding necessary analyses, including the design, development, and ongoing product testing of vehicle safety systems, such as occupant restraint systems and the design of vehicle interiors from the standpoint of occupant safety.

The need for less expensive and readily available crash tests has led to the development of non-destructive crash test arrangements in which vehicle deceleration is recorded during a full-scale crash test. This deceleration data, which is often referred to as a crash pulse, is used to control either the deceleration or acceleration of a crash sled in a manner that substantially matches the crash pulse. In such an arrangement, all or a portion of the occupant compartment of the vehicle, often referred to as a vehicle buck, is mounted on the upper surface of the crash sled. Instrumented crash test dummies occupy the vehicle buck during the deceleration or acceleration of the test buck. The instrumented dummies provide data that can be evaluated to indicate the kind and degree of occupant injury that might result from the simulated crash and/or be evaluated to determine compliance with crash safety limitations pertaining to occupant head and chest acceleration and various loads and forces that can be experienced by a human occupant during a crash event.

Current crash sled systems provide relatively accurate results with respect to replicating crash event acceleration along an axial direction that corresponds to the vehicle travel path at the time of a crash. However, most systems cannot simulate dynamic conditions, such as vehicle pitch, that can occur during a crash. Vehicle pitch occurs, for example, in frontal and rear impact crashes in which the front of the vehicle is often abruptly thrust downwardly and the rear of the vehicle is thrust upwardly. The accelerations associated with this downward and upward motion can be significant enough to cause or contribute to occupant injury.

### SUMMARY

Examples of the present disclosure relate to accelerator type crash simulation test systems. These systems provide repeatable and reliable simulation of vehicle frontal impact crash events. Employing aspects of the present disclosure, the crash simulation test systems are capable of simulating motion in the form of rotation about a vertical Z-axis and/or translation in a direction perpendicular to the motion of the ServoSled. The combination of these motions is generally known as yaw. Yaw motion is of particular interest in frontal crash events in which the center of impact is offset from the center of the vehicle. As will be described herein, the yaw motion is achieved in several embodiments by the use of off-board actuators that supply yawing motions to an onboard platform.

### DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a schematic view of a type of prior art crash test system that can advantageously incorporate aspects of the present disclosure;

FIG. 2 is one example of a crash test system with yaw simulation in accordance with aspects of the present disclosure;

FIG. 3 depicts several components of the crash test system of FIG. 2 in accordance with aspects of the present disclosure;

FIG. 4 depicts one example of a yaw platform operatively coupled to a main sled;

FIG. 5 is a perspective view of the crash test system of FIG. 2 wherein the yaw platform has been rotated in a clockwise direction;

FIG. 6 is a perspective view of the crash test system of FIG. 2 wherein the yaw platform has been rotated in a counter clockwise direction;

FIG. 7 is a perspective view of the crash test system of FIG. 2 wherein the yaw platform has been linearly translated to the right;

FIG. 8 is a perspective view of the crash test system of FIG. 2 wherein the yaw platform has been linearly translated to the left.

### DETAILED DESCRIPTION

The detailed description set forth below in connection with the appended drawings where like numerals reference like elements is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

In the following description, numerous specific details are set forth in order to provide a thorough understanding of one or more embodiments of the present disclosure. It will be apparent to one skilled in the art, however, that many embodiments of the present disclosure may be practiced without some or all of the specific details. In some instances, well-known process steps have not been described in detail in order not to unnecessarily obscure various aspects of the present disclosure. Further, it will be appreciated that embodiments of the present disclosure may employ any combination of features described herein.

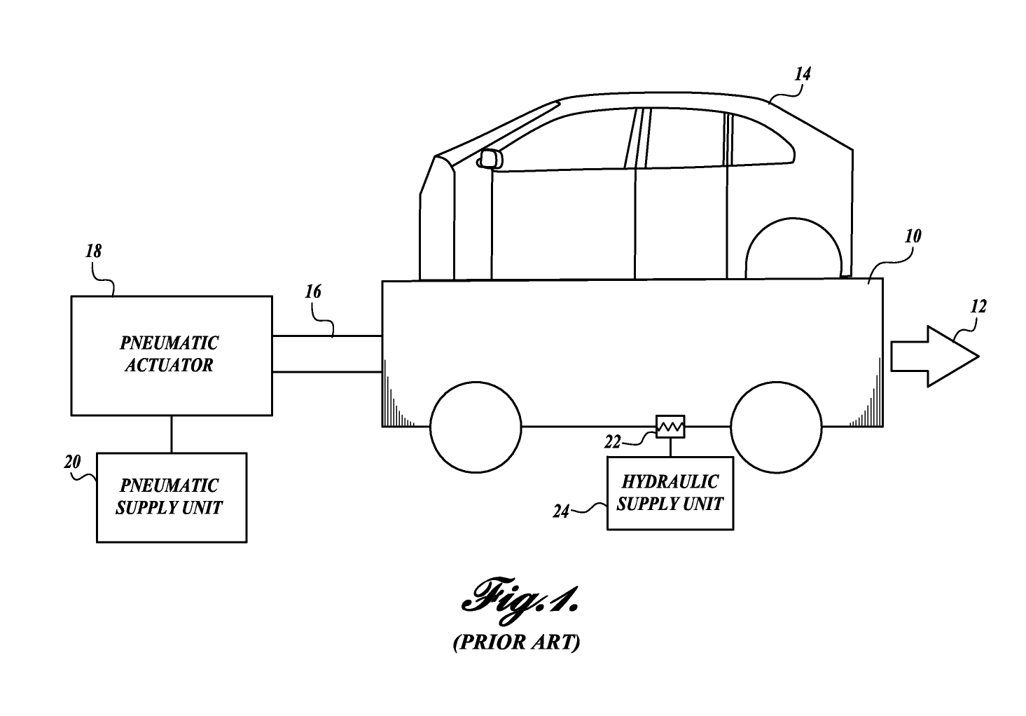

FIG. 1 illustrates the basic components of a reverse acceleration crash sled system, which is a type of system that can advantageously employ aspects of the present disclosure. In the depicted arrangement, a crash sled 10 is configured for traveling in the direction of arrow 12 along a set of rails (not shown in FIG. 1). Mounted to the upper surface of crash sled 10 is the occupant compartment 14 of a particular vehicle or type of vehicle. Prior to initiating operation of the system, crash sled 10 is positioned against the end of the piston 16 of a high-pressure pneumatic actuator 18. A pneumatic supply unit 20 increases the internal pressure of pneumatic actuator 18 to the level at which piston 16 can be driven with enough force to accelerate crash sled 10 to at least the maximum acceleration of the crash pulse being replicated. The force asserted by piston 16 is opposed by operation of hydraulically-operated friction brakes 22 that are mounted between the lower surface of crash sled 10 and the track or rails on which it travels. The friction brakes 22 are actuated with sufficient clamping force to prevent any motion of the crash sled 10 until the simulation is initiated.

To initiate the simulation procedure, a control computer (not shown in FIG. 1) causes hydraulically operated friction brakes 22 to release piston 16 so as to assert a force on the crash sled that rapidly accelerates crash sled 10 in the axial direction indicated by arrow 12 (horizontal in FIG. 1). The force asserted by piston 16 is opposed by real-time operation of hydraulically operated friction brakes 22. Specifically, servo-controlled valves that are located in a hydraulic supply unit 24 are activated by the control computer to apply a braking force that causes the acceleration of crash sled 10 to closely match a desired crash pulse. Typically, during simulation of the crash pulse, the control computer operates the servo valves as a closed-loop feedback system in which the error signal is the difference between the desired crash pulse and measured acceleration of crash sled 10. Once the simulation is complete, crash sled 10 continues to move along the track or rails until brought to a stop by a separate set of computer-controlled brakes (not shown).

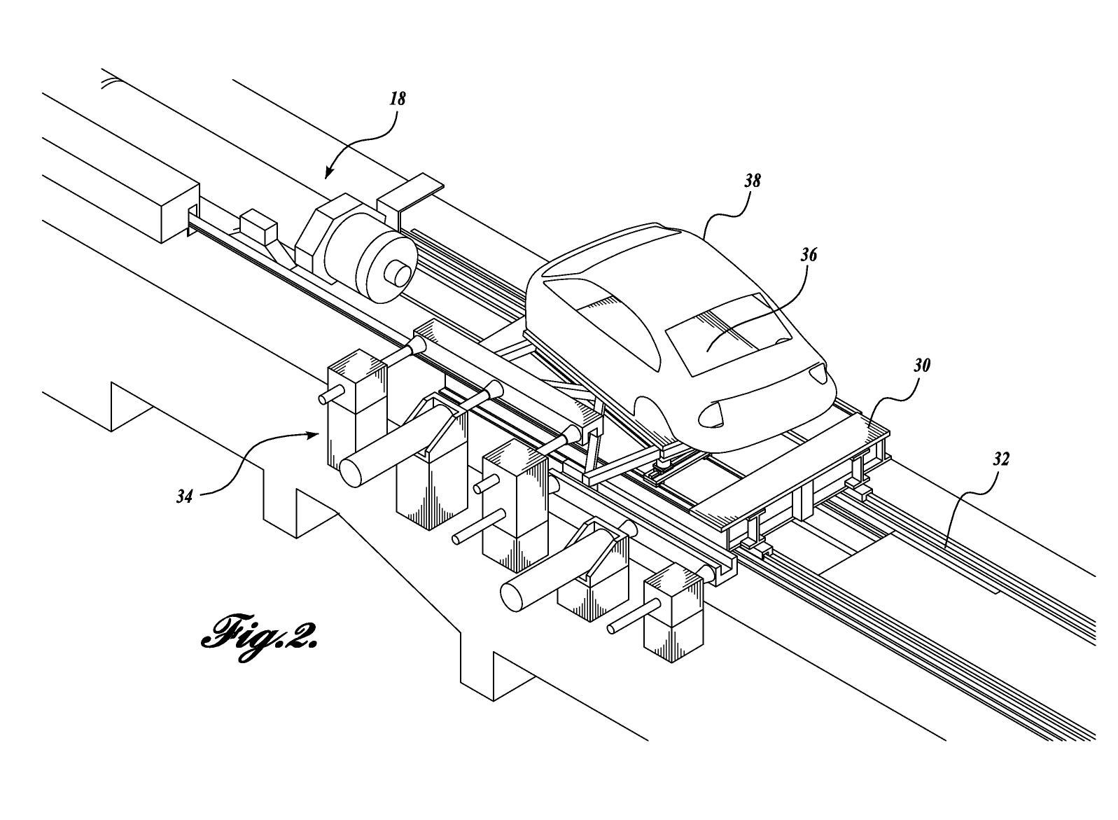

FIG. 2 depicts a first embodiment of the present disclosure configured to add yaw simulation to a crash sled system such as the arrangement of FIG. 1. In FIG. 2, a main sled 30 that is structurally and operationally equivalent to crash sled 10 of FIG. 1 in some embodiments is positioned on a set of rails 32 or other track. When launched, main sled 30 is subjected to an acceleration force sufficient to replicate a desired crash pulse and, hence, simulate a vehicle crash. As will be described in more detail below, one or more off-board yaw assemblies can be controlled so as to provide yaw motion to a test vehicle carried by the main sled 30.

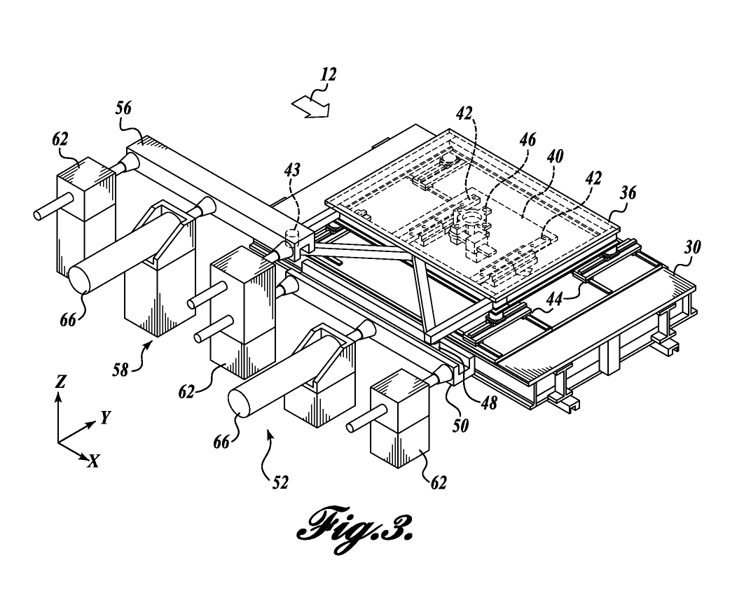

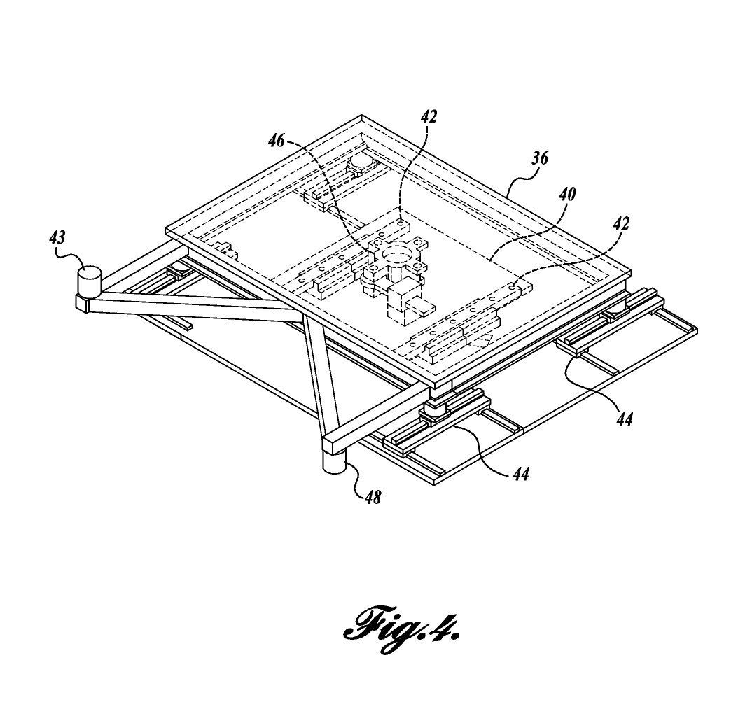

Turning now to FIGS. 3 and 4, a yaw platform 36 is positioned above the upper surface of main sled 30 and supported in a manner that allows cross slide motion along the Y-axis and/or rotation about the Z-axis of the main sled 30. An occupant compartment 38 representative of the type of vehicle under consideration (or other payload) is securely mounted to the upper surface of yaw platform 36, as best shown FIG. 2. Returning to FIGS. 3 and 4, a plate 40 or similar structure is slidably supported by and coupled on top of the main sled 30 via transversely oriented translation bearings 42. The yaw platform 36, in turn, is rotationally mounted to a plate 40 via rotation bearing 46. Guide bearings 44 are also provided between the yaw platform 36 and the main sled 30. The guide bearings 44 are arranged and configured to guide the cross-sliding movement of the yaw platform 36 with respect to the main sled 30 as well as longitudinal (i.e., X-axis) movement with respect to the main sled 30.

Extending outwardly away from the front and rear corners of yaw platform 36 via suitable brace members are guide members 48. The guide member 48 at the front corner of the yaw platform 34 passes into or is otherwise supported by guide rail 50 of a front guide assembly 52, and the guide member 48 at the rear corner of yaw platform 34 passes into or is otherwise supported by guide rail 56 of a rear guide assembly 58. Front and rear guide assemblies 52 and 58 control the trajectory (and, hence, yaw) of yaw platform 36 when main sled 30 is launched to replicate a desired acceleration pulse. That is, concurrent with movement of main sled 30 in the direction of arrow 12, the yaw platform 36 moves laterally and/or rotates about the Z-axis along a guide path established by front guide assembly 52 and the rear guide assembly 58. To facilitate movement along the front and rear guide assemblies, guide members 48 may include or be formed as rollers or may be configured to simply slide along the paths established by the front and rear guide assemblies. In some embodiments of the present disclosure, the rails 50 and 56 are of sufficient length to provide roller guiding over the entire length of the crash test system's test stroke.

In the arrangement of FIG. 3, the front and rear guide assemblies 52 and 58 are positioned adjacent the main sled 30 and include rail supports 62. Bearings or equivalent devices included in the rail supports 62 allow the front and rear guide assemblies 52 and 58 to be translated linearly along the Y-axis relative to the associated rail supports 62. The guide rails 50 and 56 can be translated via controllable linear actuators 68. Each actuator 66 can be moved independently of the other.

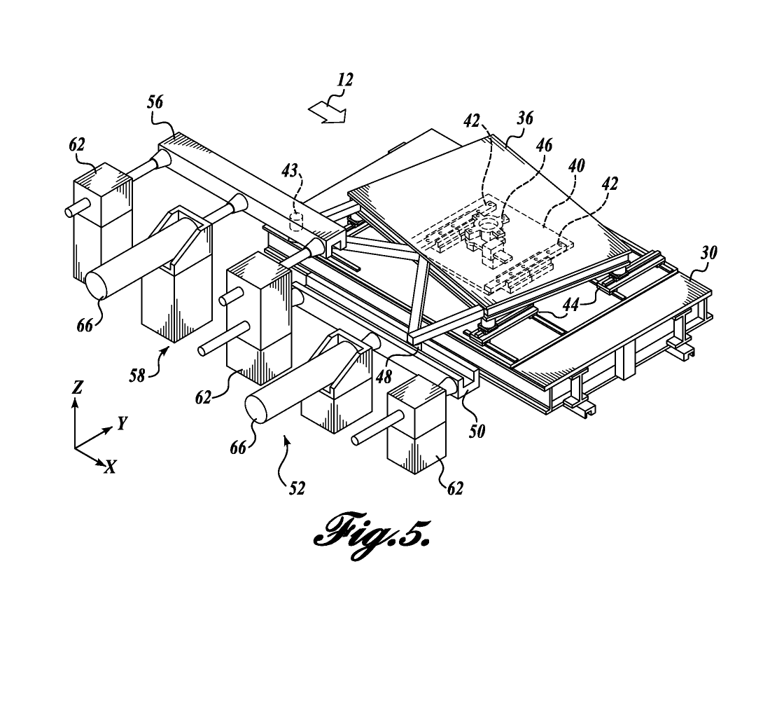

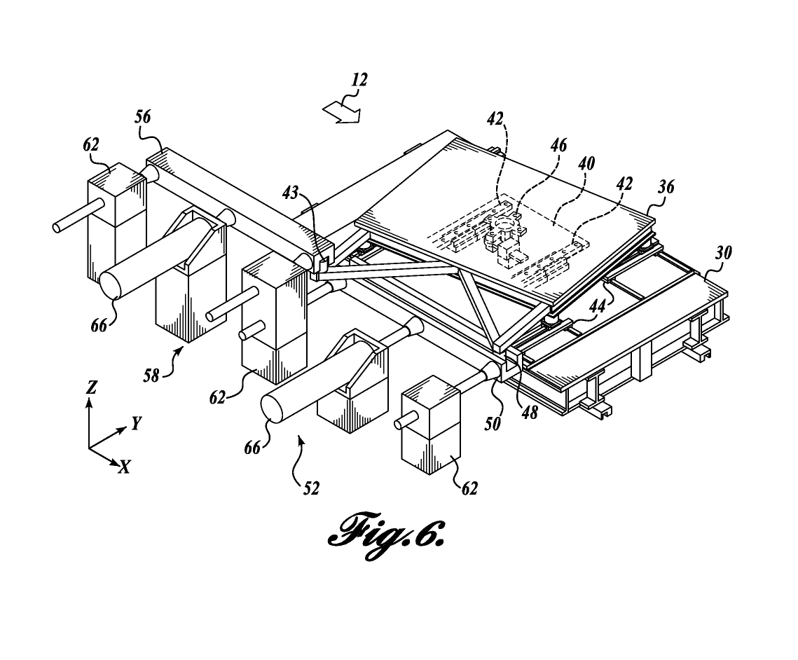

In operation, by extending one actuator further than the other, front and rear corners of the yaw platform 36 will be at two different distances from the center of the main sled 30, as shown in FIGS. 5 and 6. This causes the yaw platform 36 to rotate. If the rear corner is extended further than the front corner the yaw platform 36 will obtain a clockwise rotation, as shown in FIG. 5. If the front corner is extended further than the rear corner the yaw platform 36 will obtain a counter clockwise rotation, as best shown in FIG. 5.

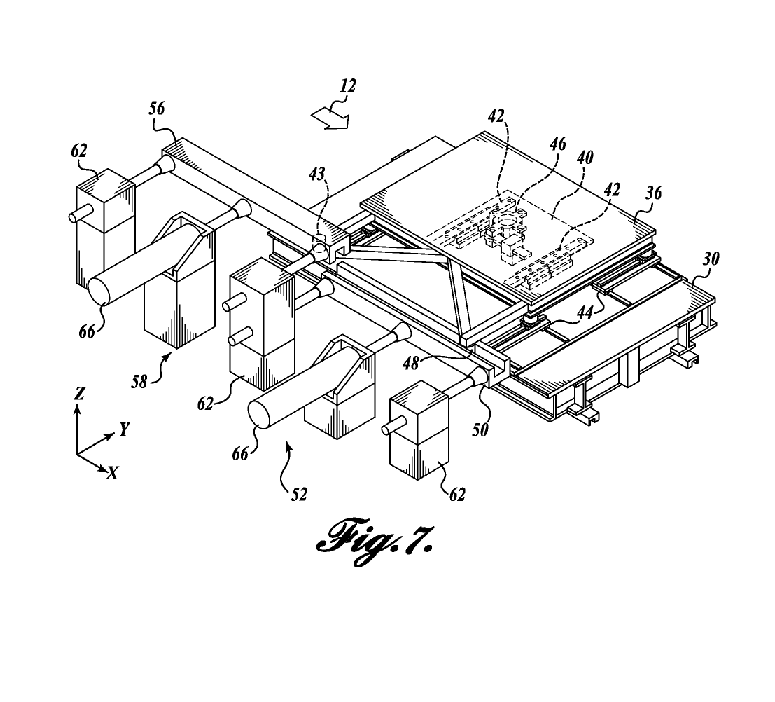

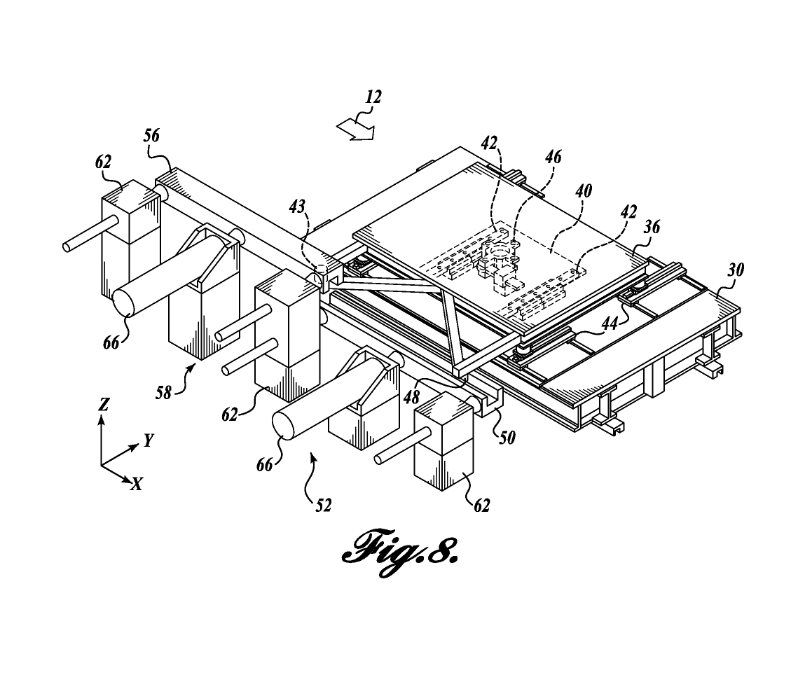

Cross slide, or motion along the Y-axis, of the yaw platform 36 can be accomplished by operating the actuators 66 identically so that the actuators are moved together. As a result, the yaw platform 36 will translate across the main sled 30. Extending the actuators 66 toward the main sled 30, will move the yaw platform 36 to the right, as shown in FIG. 7. Retracting the actuators 66 away from the main sled 30 will move the yaw platform to the left, as shown in FIG. 8.

As rotation in either direction and cross slide in either direction can be provided by the actuators, suitable control of actuator extension and retraction provides any desired combination of yawing motion. For example extending the actuators towards the main sled 30 while advancing rear actuator faster than the front actuator, provides right cross slide with counter clock wise rotation. Similarly retracting the actuators away from the main sled 30 while the rear actuator retracts faster than the front actuator provides left translation with clockwise rotation.

Various types of actuators can be employed as the linear actuators 66, such as electromechanical or hydraulic linear actuators. Such linear actuators 66 can be controlled by the system computer and set at desired positioned during the pre-launch procedure and moved to desired positions during simulation of the crash test. Preferably, sensors (not shown in the FIGURES) are either included in or are mounted near linear actuators 66. The sensors indicate the amount of travel of the rails 52 and 56, and the thus, provide a feedback signal regarding the position of the yaw platform 36. Parking brakes are provided to hold the yaw platform 36 in place after the rollers have left the guides thereby preventing unwanted additional platform motion.

As has be described herein, simulating yaw in the described manner relies entirely on the guide paths established by the front and rear guide assemblies 52 and 58 and the rate of movement of each guide assembly via actuation of the respective actuators. That is, during the simulation process, acceleration force causes acceleration of main sled 30. As main sled accelerates, yaw platform guide members 48 are constrained to follow the guide paths of front and rear guide assemblies 52 and 58. The only forces that act on the yaw platform 36 are the forward acceleration force and the forces caused by reaction between the guide members 48 of the yaw platform 36 and the movable guide paths of the front and rear guide assemblies 52 and 58.

It should be noted that for purposes of this disclosure, terminology such as “upper,” “lower,” “vertical,” “horizontal,” “inwardly,” “outwardly,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure.

The embodiments of the invention in which an exclusive property or privilege is claimed are defined as follows:

1. A crash test apparatus configured to provide yaw simulation.

2. A crash test apparatus comprising:
a main sled;
a yaw sled operatively mounted on the main sled and movable in rotation about a vertical Z-axis and/or translation in a direction perpendicular to the motion of the main sled; and
means for imparting yaw motion to the yaw sled during operation of the crash test apparatus

3. The crash test apparatus of claim 2, wherein said means includes one or more actuators independently movable with respect to the main sled.

4. The crash test apparatus of claim 3, wherein said means includes one or more off-board actuators configured to impart forces onto the yaw sled.
